(19) United States
(12) Patent Application Publication
(10) Pub. No.: US 2018/0363570 A1
(43) Pub. Date: Dec. 20, 2018

(54) INTERNAL COMBUSTION ENGINE HAVING AN INJECTION AMOUNT CONTROL

(71) Applicant: GE Jenbacher GmbH & Co OG, Jenbach (AT)

(72) Inventors: Medy SATRIA, München (DE); Dino IMHOF, Baden (CH); Raphael BURGMAIR, Feldkirchen-Westerham (DE)

(21) Appl. No.: 15/772,450

(22) PCT Filed: Nov. 3, 2016
(86) PCT No.: PCT/AT2016/060100

§ 371 Date: Apr. 30, 2018

(30) Foreign Application Priority Data
Nov. 4, 2015 (EP) 15192919.7

(51) Int. Cl. F02D 19/10; F02D 41/14; F02D 19/06; F02D 41/00; F02D 41/24

(52) U.S. Cl. CPC F02D 19/105; F02D 41/1402; F02D 19/061; F02D 19/0628; F02D 2200/063; F02D 41/247; F02D 2041/1416; F02D 2041/1433; F02D 2200/0602; F02D 41/0027

(57) ABSTRACT

An internal combustion engine including a control device, at least one combustion chamber, and at least one injector for injecting liquid fuel into the at least one combustion chamber is provided. The injector can be controlled by the control device by means of an actuator control signal. An algorithm is stored in the control device, which algorithm receives the actuator control signal and using an injector model calculates the amount of liquid fuel that is discharged via the discharge opening of the injector and compares the amount of liquid fuel calculated by means of the injector model with a desired target value of the amount of liquid fuel. Depending on the result of the comparison, the control device leaves the actuator control signal the same or corrects it.

### TECHNOLOGY FIELD

Embodiments of the disclosure relate to an internal combustion engine with the features of the preamble of claim 1 and a method with the features of the preamble of claim 11 or 12.

### BACKGROUND

A class-specific internal combustion engine and a class-specific method for the determination of the injection duration are derived from DE 10 2009 056 381 A1.

The problem is at the present state of the art that the controls of the injector used do not guarantee a sufficient precision of the injected amount of liquid fuel over the service life of the injector.

### BRIEF DESCRIPTION

The object of embodiments of the disclosure is to provide an internal combustion engine and a method in which a control of the injector with a sufficient precision of the injected amount of liquid fuel can take place, particularly over the service life of the injector.

This object is achieved by an internal combustion engine with the features of claim 1 and a method with the features of claim 11 or 12. Embodiments of the disclosure are defined in the dependent claims.

An example of the liquid fuel is diesel. It could also be heavy oil or another self-igniting fuel.

By storing an algorithm in the control device, which receives at least the actuator control signal as an input variable and calculates the amount of liquid fuel (e.g. diesel) that is discharged via the discharge opening of the injector by means of the injector model and compares the amount calculated by means of the injector model with a desired target value of the amount of liquid fuel and leaves the actuator control signal the same or corrects it in accordance with the result of the comparison, it is possible to control the amount of liquid fuel over the entire service life of the injector. This makes it possible to always work at the allowable limit for the pollutant emissions.

The algorithm estimates an amount of injected liquid fuel based on the actuator control signal. Embodiments of the disclosure then start from the amount of injected fuel calculated by the algorithm and compares this value with the desired target value. In the case of deviations, they can be corrected immediately (e.g. within 10 milliseconds).

Instead of the amount of injected fuel, it is of course also possible to calculate the volume or other variables which are characteristic of a certain amount of injected fuel. All these possibilities are covered in this disclosure when using the term “amount”.

According to embodiments of the disclosure, the injector comprises at least an input storage chamber connected with a common rail of the internal combustion engine a storage chamber for liquid fuel connected to said input storage chamber a volume connected to the storage chamber via needle seat a connection volume connected on one side to the storage chamber and on the other side to a drain line a discharge opening for liquid fuel, which can be closed by a needle and is connected to the volume via a needle seat an actuator controllable by means of the actuator control signal, more particularly, a solenoid valve, for opening the needle, more particularly, a control chamber connected on one side to the storage chamber and on the other side to the connection volume.

According to embodiments of the disclosure, the injector model comprises at least (not more than) pressure progressions in the input storage chamber, the storage chamber, the volume over the needle seat and the connection volume and, where appropriate, the control chamber mass flow rates between the input storage chamber, the storage chamber, the volume over the needle seat and the connection volume and, where appropriate, the control chamber a position of the needle, more particularly, relative to the needle seat dynamics of the actuator of the needle, more particularly, dynamics of a solenoid valve.

In this way, one gets a control functioning in real time in an ECU (electronic control unit) of the internal combustion engine that is sufficiently precise to control the injected amount of liquid fuel.

In an embodiment, at least one sensor is provided, by which at least one measurement variable of the at least one injector can be measured, whereby the sensor is in, or can be brought into, a signal connection with the control device. In this case, the algorithm can calculate the amount of liquid fuel that is discharged through the discharge opening of the injector by taking into account the at least one measurement variable via the injector model. Of course, it is also possible to use several measured variables to estimate the applied amount of liquid fuel that is discharged.

It is, in an embodiment, provided that the algorithm has a pilot control which calculates a pilot control command (also referred to as “pilot control signal”) for the actuator control signal for the injection duration from the desired target value of the amount of liquid fuel. The pilot control ensures a fast system response, since it controls the injector with an injection duration as if no injector variability would exist. The pilot control uses, for example, an injector map (which, for example, in the case of an actuator designed as a solenoid valve, indicates the duration of current flow over the injection amount or volume) or an inverted injector model to convert the target value of the amount of liquid fuel to be injected into the pilot control command for the injection duration.

When the control device is designed with pilot control, it can be particularly provided that the algorithm comprises a feedback loop, which, taking into account the pilot control command for the injection duration calculated by the pilot control and the at least one measurement variable by means of the injector model, calculates the amount of liquid fuel discharged via the discharge opening of the injector and, if necessary, (if there is a deviation) corrects the target value calculated by the pilot control for the injection duration. The feedback loop is used to correct the inaccuracies of the pilot control (due to manufacturing variabilities, wear, etc.), which cause an injector drift.

The algorithm has, in an embodiment, an observer which, using the injector model, estimates the injected amount of liquid fuel depending on the at least one measurement variable and the at least one actuator control signal. An actual measurement of the injected amount of liquid fuel is therefore not required for the feedback loop. Regardless of whether a feedback loop is provided, the injected amount of liquid fuel in the pilot control estimated by the observer can be used to improve the actuator control signal.

Various possible formations of the observer are known to the person skilled in the art from the literature (e.g. Luenberger observer, Kalman filter, “sliding mode” observer, etc.).

The observer can also serve to take into account, with the help of the injector model, the state of the injector that changes over the life of the injector (e.g. due to aging or wear) to improve the pilot control signal and/or the actuator control signal.

Essentially it is possible to calculate the actuator control signal on the basis of the target value for the injected amount of liquid fuel and on the basis of the amount of liquid fuel estimated by the observer. In this way, an adaptive pilot control signal, modified by the observer, is obtained. In this case, the control is therefore not composed of two parts, with a pilot control and a feedback loop which corrects the pilot control signal.

The needle is usually pretensioned against the opening direction by a spring.

An injector can also be provided, which has no control chamber, e.g. an injector in which the needle is controlled by a piezoelectric element.

The at least one measurement variable can, for example, be selected from the following variables or a combination thereof pressure in a common rail of the internal combustion engine, pressure in an input storage chamber of the injector, pressure in a control chamber of the injector, start of the needle lift-off from the needle seat

The control device can be designed to execute the algorithm during each combustion cycle or selected combustion cycles of the internal combustion engine and to correct the actuator control signal in the case of deviations during this combustion cycle.

Alternatively, the control device may be designed to execute the algorithm during each combustion cycle or selected combustion cycles of the internal combustion engine and in case of deviations to correct the actuator control signal in one of the subsequent combustion cycles, in an embodiment, in the immediate subsequent combustion cycle.

Alternatively, or in addition to one of the above-mentioned embodiments, the control device may be designed to execute the algorithm during each combustion cycle or selected combustion cycles of the internal combustion engine and to statically evaluate the deviations that have occurred and to make a correction for this or one of the subsequent combustion cycles in accordance with the static evaluation.

It is not absolutely necessary for embodiments of the disclosure to measure the amount of injected liquid fuel directly. It is also not necessary to deduce directly from the at least one measurement variable the actual injected amount of liquid fuel.

Embodiments of the disclosure can be used in a stationary internal combustion engine, for marine applications or mobile applications such as so-called “non-road mobile machinery” (NRMM), more particularly as a reciprocating piston engine. The internal combustion engine can be used as a mechanical drive, e.g. for operating compressor systems or coupled with a generator to a genset for generating electrical energy.

The internal combustion engine can comprise at least one gas supply device for the supply of a gaseous fuel to at least one combustion chamber and the internal combustion engine can be designed as a dual-fuel internal combustion engine.

Dual-fuel internal combustion engines are typically operated in two operating modes. We differentiate between an operating mode with a primary liquid fuel supply (“liquid operation” for short; in the event diesel is used as a liquid fuel, it is called “diesel operation”) and an operating mode with a primarily gaseous fuel supply, in which the liquid fuel serves as a pilot fuel for initiating combustion (called “gas operation”, “pilot operation”, or “ignition-jet operation”). An example of the liquid fuel is diesel. It could also be heavy oil or another self-igniting fuel. An example of the gaseous fuel is natural gas. Other gaseous fuels, such as biogas, etc., are also suitable.

In pilot operation, a small amount of liquid fuel is introduced into a piston cylinder unit as a so-called pilot injection. As a result of the conditions prevailing at the time of injection, the introduced liquid fuel ignites and detonates a mixture of gaseous fuel and air present in the piston cylinder unit. The amount of liquid fuel in a pilot injection is typically 0.5-5% of the total amount of energy supplied to the piston cylinder unit in a work cycle of the internal combustion engine.

To clarify the terms, it is defined that the internal combustion engine is operated either in pilot operation or in diesel operation. With regard to the control device, the pilot operation of the internal combustion engine is referred to as a pilot mode and a diesel operation of the internal combustion engine is referred to as diesel mode.

A ballistic range is understood to be an operation of the fuel injector in which the injection needle moves from a “fully closed” position in the direction of a “fully open” position but does not reach it. As a result, the injection needle moves back in the direction of the “fully closed” position without having reached the “fully open” position.

The substitution rate indicates the proportion of the energy supplied to the internal combustion engine in the form of the gaseous fuel. Substitution rates of between 98 and 99.5% are targeted. Such high substitution rates require a design of the internal combustion engine in terms of, for example, the compression ratio as it corresponds to that of a gas engine. The sometimes conflicting demands on the internal combustion engine for a pilot operation and a liquid operation lead to compromises in the design, for example in terms of the compression ratio.

### BRIEF DESCRIPTION OF THE DRAWINGS

Exemplary embodiments of the invention will be explained with reference to the figures. They are as follows:

FIG. 1 a first exemplary embodiment of the control scheme;

FIG. 2 a second exemplary embodiment of the control scheme;

FIG. 3 a first example of a schematically illustrated injector; and

FIG. 4 a second example of a schematically illustrated injector.

### DETAILED DESCRIPTION

It should be noted that the gas supply device for the supply of gaseous fuel to the at least one combustion chamber (apart from the schematically represented valves) or the corresponding control or regulation are shown in none of the figures. They correspond to the state of the art.

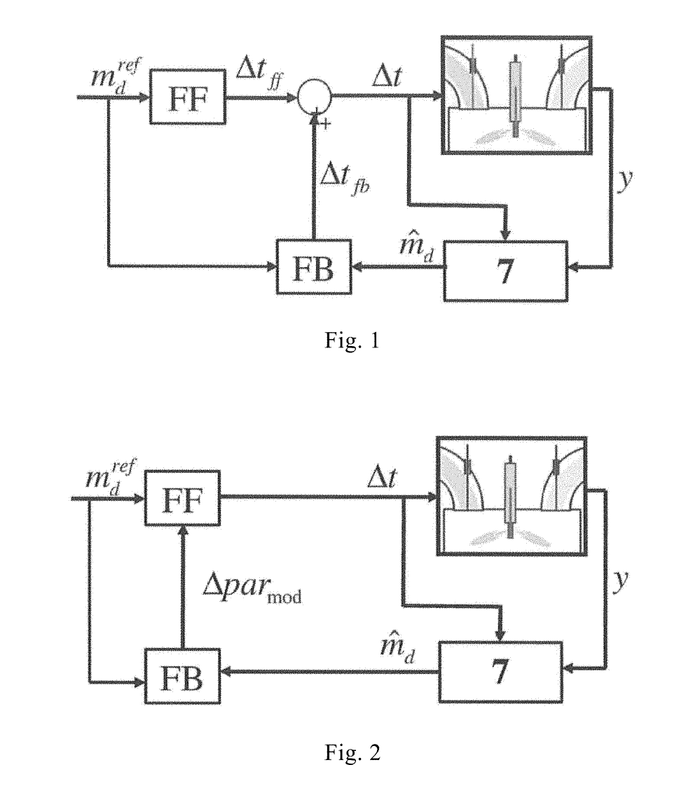

FIG. 1:

The object of the injector control in this exemplary embodiment is the control of the actual injected amount of liquid fuel to a target value m_{d}^{ref}, by controlling the injection duration Δt. The control strategy is performed by a pilot control (FF), which calculates, from a desired target value m_{d}^{ref} for the amount of liquid fuel, a pilot control signal Δt_{ff} (hereinafter also referred to as “control command”) for the injection duration Δt, and a feedback loop (FB) which, using an observer 7 (“state estimator”) and taking into account the control command calculated by the pilot control for the injection duration Δt and at least one measurement variable y (e.g. one of the pressure progressions p_{IA}, p_{CC}, p_{JC}, p_{AC}, p_{SA}, occurring in the injector or the start of the lift-off from the needle seat) estimates the mass flow \hat{m}_{d} of liquid fuel discharged via the discharge opening of the injector by means of an injector model and, if necessary, corrects the target value Δt_{ff} calculated by the pilot control for the injection duration to the actual duration of the actuator control signal Δt by means of a correction value Δt_{fb} (which can be negative).

The pilot control ensures a fast system response, since it controls the injector with an injection duration Δt as if no injector variability existed. The pilot control uses a calibrated injector map (which indicates the duration of current flow over the injection amount or volume) or the inverted injector model to convert the target value m_{d}^{ref} of the amount of liquid fuel into the pilot control command Δt_{ff} for the injection duration.

The feedback loop (FB) is used to correct the inaccuracies of the pilot control (due to manufacturing variabilities, wear, etc.), which cause an injector drift. The feedback loop compares the target value m_{d}^{ref} with the estimated injected amount of liquid fuel \hat{m}_{d} and gives as feedback a correction control command Δt_{fb} for the injection duration, if there is a discrepancy between m_{d}^{ref} and \hat{m}_{d}. The addition of Δt_{ff} and Δt_{fb} gives the final injection duration Δt.

The observer estimates the injected amount \hat{m}_{d} of liquid fuel, which is dependent on the at least one measurement variable y and the final injection duration Δt. The at least one measurement variable y can refer to: common rail pressure p_{CR}, pressure in the input storage chamber p_{IA}, pressure in the control chamber p_{CC}, and the start of the needle lift-off from the needle seat. The observer uses a reduced injector model to estimate the injected amount \hat{m}_{d} of liquid fuel.

FIG. 2:

This figure shows a one-piece control (without pilot control command Δt_{ff}), in which the actuator control signal Δₜ is calculated based on the target value m_{d}^{ref} for the injected amount of liquid fuel and based on the parameter Δgar_{mod} used in the pilot control model and estimated by the observer. In this way, an adaptive pilot control signal, modified by the observer, is obtained. In this case, the control is therefore not composed of two parts, with a pilot control and a feedback loop which corrects the pilot control signal.

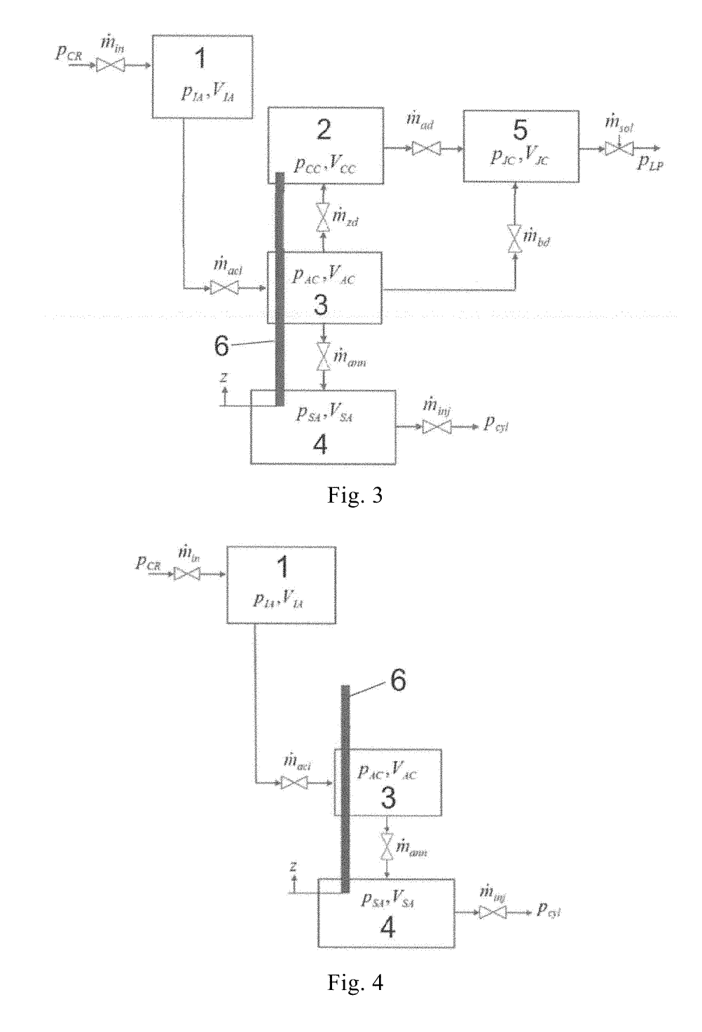

FIG. 3 shows a block diagram of a reduced injector model. The injector model consists of a structural model of the injector and an equation system to describe the dynamic behavior of the structural model. The structural model consists of five modeled volumes: input storage chamber 1, storage chamber 3, control chamber 2, volume over needle seat and connection volume 5.

The input storage chamber 1 represents the summary of all volumes between the input throttle and the check valve. The storage chamber 3 represents the summary of all volumes from the check valve to the volume above the needle seat. The volume over the needle seat represents the summary of all volumes between the needle seat to the discharge opening of the injector. The connection volume 5 represents the summary of all volumes which connects the storage chamber 3 and the control chamber 2 with the solenoid valve.

FIG. 4 shows an alternatively designed injector which does not require control chamber 2, e.g. an injector in which the needle 6 is controlled by a piezoelectric element.

The following equation system does not relate to the embodiment shown in FIG. 4. The formulation of a corresponding equation system can be performed analogously to the equation system shown below.

The dynamic behavior of the structural model is described by the following equation systems:

Pressure Dynamics

The evolution over time of the pressure within each of the volumes is calculated based on a combination of the mass conservation rate and the pressure-density characteristic of the liquid fuel. The evolution over time of the pressure results from:

$$\begin{matrix}{\dot{p}}_{IA} = \frac{{K}_{f}}{{ρ}_{IA} {V}_{IA}} ( {\dot{m}}_{i n} - {\dot{m}}_{aci} ) & Eq . 1.1 \\ {\dot{p}}_{CC} = \frac{{K}_{f}}{{ρ}_{CC} {V}_{CC}} ( {\dot{m}}_{zd} - {\dot{m}}_{ad} - {ρ}_{CC} {\dot{V}}_{CC} ) & Eq . 1.2 \\ {\dot{p}}_{JC} = \frac{{K}_{f}}{{ρ}_{JC} {V}_{JC}} ( {\dot{m}}_{bd} + {\dot{m}}_{ad} - {\dot{m}}_{sol} ) & Eq . 1.3 \\ {\dot{p}}_{A C} = \frac{{K}_{f}}{{ρ}_{A C} {V}_{A C}} ( {\dot{m}}_{aci} - {\dot{m}}_{ann} - {\dot{m}}_{bd} - {\dot{m}}_{zd} - {ρ}_{A C} {\dot{V}}_{A C} ) & Eq . 1.4 \\ {\dot{p}}_{SA} = \frac{{K}_{f}}{{ρ}_{SA} {V}_{SA}} ( {\dot{m}}_{ann} - {\dot{m}}_{inj} - {ρ}_{SA} {\dot{V}}_{SA} ) & Eq . 1.5\end{matrix}$$

Formula Symbols Used

p_{IA}: Pressure in the input storage chamber 1 in bar
p_{CC}: Pressure in the control chamber 2 in bar
p_{JC}: Pressure in the connection volume 5 in bar
p_{AC}: Pressure in the storage chamber 3 in bar
p_{SA}: Pressure in the small storage chamber 4 in bar
p_{IA}: Diesel mass density within the input storage chamber 1 in kg/m³
p_{CC}: Diesel mass density within the control chamber 2 in kg/m³
p_{JC}: Diesel mass density within the connection volume 5 in kg/m³
p_{AC}: Diesel mass density within the storage chamber 3 in kg/m³
p_{SA}: Diesel mass density within the small storage chamber 4 in kg/m³
K_{f}: Bulk modulus of diesel fuel in bar

Needle Dynamics

The needle position is calculated by the following equation of motion:

$$\begin{matrix}\ddot{z} = \{ \begin{matrix}0 if {F}_{hyd} \leq {F}_{pre} \\ \frac{1}{m} ( {F}_{hyd} - Kz - Bz - {F}_{pre} ) if {F}_{hyd} > {F}_{pre}\end{matrix} & Eq . 2.1 \\ {F}_{hyd} = {p}_{A C} {A}_{A C} + {p}_{SA} {A}_{SA} - {p}_{CC} {A}_{CC} & Eq . 2.2 \\ 0 \leq z \leq {z}_{ma x} & Eq . 2.3\end{matrix}$$

Formula Symbols Used:

Z: Needle position in meters (m)
Zₘₐₛ: Maximum deflection of the needle 6 in m
K: Spring stiffness in N/m
B: Spring damping coefficient in N·s/m
Fₚᵣₑ: Spring pretensioning in N
A_{AC}: Hydraulic effective area in the storage chamber 3 in m²
A_{SA}: Hydraulic effective area in the small storage chamber 4 in m²
A_{CC}: Hydraulic effective area in the control chamber 2 in m²

Dynamics of the Solenoid Valve

The solenoid valve is modeled by a first order transfer function, which converts the valve opening command in a valve position. This is given by:

The transient system behavior is characterized by the time constant τsol and the position of the needle 6 at the maximum valve opening is given by zmax sol. Instead of a solenoid valve, piezoelectric actuation is also possible.

Mass Flow Rates

The mass flow rate through each valve is calculated from the standard throttle equation for liquids, which is:

$$\begin{matrix}{\dot{m}}_{i n} = {A}_{i n} {C}_{din} \sqrt{2 {ρ}_{j} \vert {p}_{CR} - {p}_{IA} \vert} \cdot sgn ( {p}_{CR} - {p}_{IA} ) & Eq . 3.1 \\ {\dot{m}}_{bd} = {A}_{bd} {C}_{dbd} \sqrt{2 {ρ}_{j} \vert {p}_{A C} - {p}_{JC} \vert} \cdot sgn ( {p}_{A C} - {p}_{JC} ) & Eq . 3.2 \\ {\dot{m}}_{zd} = {A}_{zd} {C}_{dzd} \sqrt{2 {ρ}_{j} \vert {p}_{A C} - {p}_{CC} \vert} \cdot sgn ( {p}_{ A C} - {p}_{CC} ) & Eq . 3.3 \\ {\dot{m}}_{ad} = {A}_{ad} {C}_{dad} \sqrt{2 {ρ}_{j} \vert {p}_{CC} - {p}_{JC} \vert} \cdot sgn ( {p}_{CC} - {p}_{JC} ) & Eq . 3.4 \\ {\dot{m}}_{sol} = {A}_{sol} {C}_{dsol} \sqrt{2 {ρ}_{j} \vert {p}_{JC} - {p}_{LP} \vert} \cdot sgn ( {p}_{IA} - {p}_{ A C} ) & Eq . 3.5 \\ {\dot{m}}_{aci} = {A}_{aci} {C}_{daci} \sqrt{2 {ρ}_{j} \vert {p}_{IA} - {p}_{A C} \vert} \cdot sgn ( {p}_{IA} - {p}_{A C} ) & Eq . 3.6 \\ {\dot{m}}_{ann} = {A}_{ann} {C}_{ann} \sqrt{2 {ρ}_{j} \vert {p}_{A C} - {p}_{SA} \vert} \cdot sgn ( {p}_{A C} - {p}_{SA} ) & Eq . 3.7 \\ {\dot{m}}_{inj} = {A}_{inj} {C}_{dinj} \sqrt{2 {ρ}_{SA} \vert {p}_{SA} - {p}_{cyl} \vert} \cdot sgn ( {p}_{SA} - {p}_{cyl} ) & Eq . 3.8 \\ {ρ}_{j} = \{ \begin{matrix}{ρ}_{i n} if {p}_{i n } \geq {p}_{out} \\ {ρ}_{out} if {p}_{i n} < {p}_{out}\end{matrix} & Eq . 3.9\end{matrix}$$

Formula Symbols Used:
\dot{m}ᵢₙ: Mass flow density through the input throttle in kg/s
\dot{m}_{bd}: Mass flow rate through the bypass valve between storage chamber 3 and the connection volume 5 in kg/s
\dot{m}_{zd}: Mass flow rate through the feed valve at the inlet of control chamber 2 in kg/s
\dot{m}_{ad} Mass flow rate through the outlet valve of control chamber 2 in kg/s
\dot{m}ₛₒₗ: Mass flow rate through the solenoid valve in kg/s
   \dot{m}_{aci}: Mass flow rate through the inlet of storage chamber 3 in kg/s
   \dot{m}ₐₙₙ: Mass flow rate through the needle seat in kg/s
   \dot{m}ᵢₙⱼ: Mass flow rate through the injector nozzle in kg/s

Based on the above formulated injector model, the person skilled in the art obtains by means of the observer in a known manner (see, for example, Isermann, Rolf, “Digital Control Systems”, Springer Verlag Heidelberg 1977 chapter 22.3.2, page 379 et seq., or F. Castillo et al, “Simultaneous Air Fraction and Low-Pressure EGR Mass Flow Rate Estimation for Diesel Engines”, IFAC Joint conference SSSC—5th Symposium on System Structure and Control, Grenoble, France 2013) the estimated value \hat{m}_{d}.

Using the above-mentioned equation systems, the so-called “observer equations” are constructed, using a known per se observer of the “sliding mode observer” type, by adding the so-called “observer law” to the equations of the injector model. In a “sliding mode” observer, the observer law is obtained by calculating a “hypersurface” from the at least one measuring signal and the value resulting from the observer equations. By squaring the hypersurface equation, we obtain a generalized Ljapunov equation (generalized energy equation). This is a functional equation. The observer law is the function that minimizes the functional equation. This can be determined by the variation techniques known per se or numerically. This process is carried out within one combustion cycle for each time step (depending on the time resolution of the control).

The result, depending on the application, is the estimated injected amount of liquid fuel, the position of the needle 6 or one of the pressures in one of the volumes of the injector.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An internal combustion engine comprising:
a control device;
at least one combustion chamber; and
at least one injector for injecting liquid fuel into the at least one combustion chamber, the at least one injector controlled by the control device by means of an actuator control signal, wherein the at least one injector comprises a discharge opening for the liquid fuel which can be closed by a needle; wherein
an algorithm is stored in the control device, which receives as an input variable at least the actuator control signal and using an injector model calculates an amount of liquid fuel discharged via the discharge opening of the injector and compares the amount of liquid fuel calculated by means of the injector model with a desired target value of the amount of liquid fuel and depending on the result of the comparison, leaves the actuator control signal the same or corrects it; wherein
the injector comprises at least:
an input storage chamber connected to a common rail of the internal combustion engine,
a storage chamber for the liquid fuel connected to the input storage chamber,
a volume connected over a needle seat to the storage chamber;
a connection volume connected on one side to the storage chamber and on an other side to a drain line;
the discharge opening for the liquid fuel, which can be closed by the needle and is connected to the volume over the needle seat;
an actuator controllable by means of the actuator control signal for opening the needle;
the control chamber connected on one side to the storage chamber and on the other side to the connection volume; and the injector model comprises at least:
pressure progressions in the input storage chamber, the storage chamber, the volume over the needle seat and the connection volume;
mass flow rates between the input storage chamber, the storage chamber, the volume over the needle seat and the connection volume;
a position of the needle, preferably relative to the needle seat; and
dynamics of the actuator of the needle.

2. The internal combustion engine according to claim 1, wherein the algorithm comprises a pilot control, which from the desired target value of the amount of liquid fuel calculates a pilot control signal for the actuator control signal for the injection duration.

3. The internal combustion engine according to claim 1, wherein at least one sensor is provided, by which at least one measurement variable of the at least one injector can be measured, wherein the sensor is in, or can be brought into, a signal connection with the control device.

4. The internal combustion engine according to claim 3, wherein the algorithm comprises a feedback loop, which, based on the actuator control signal calculated by the pilot control for the injection duration and the at least one measurement variable, calculates the amount of liquid fuel discharged via the discharge opening of the injector by means of an injector model and, if necessary, corrects the target value for the injection duration.

5. The internal combustion engine according to claim 1, wherein the algorithm comprises an observer, which, using the injector model and based on the actuator control signal and the at least one measurement variable, estimates the injected amount of liquid fuel.

6. The internal combustion engine according to claim 1, wherein the at least one measurement variable is selected from the following variables or a combination thereof:
pressure in the common rail of the internal combustion engine;
pressure in the input storage chamber of the injector;
pressure in the control chamber of the injector; and
start of the needle lift-off from the needle seat.

7. The internal combustion engine according to claim 1, wherein the control device is designed to execute the algorithm during each combustion cycle or selected combustion cycles of the internal combustion engine and to correct the actuator control signal in the case of deviations during this combustion cycle.

8. The internal combustion engine according to claim 1, wherein the control device is designed to execute the algorithm during each combustion cycle or selected combustion cycles of the internal combustion engine and in case of deviations to correct the actuator control signal in one of the subsequent combustion cycles.

9. The internal combustion engine according to claim 1, wherein the control device is designed to execute the algorithm during each combustion cycle or selected combustion cycles of the internal combustion engine and to statically evaluate the deviations that have occurred and to make a correction of the actuator control signal for this or one of the subsequent combustion cycles in accordance with the static evaluation.

10. The internal combustion engine according to claim 1, wherein at least one gas supply device for the supply of a gaseous fuel to the at least one combustion chamber is provided and the internal combustion engine is designed as a dual-fuel internal combustion engine.

11. A method for operating the internal combustion engine according to claim 1, comprising: supplying the at least one combustion chamber of the internal combustion engine with the liquid fuel, wherein the amount of liquid fuel supplied to the at least one combustion chamber is calculated depending on the actuator control signal of the actuator of the injector for the liquid fuel and a measurement variable of the injector by using the injector model, and the actuator control signal is corrected in the event of deviations between the target value for the amount of liquid fuel and the calculated amount.

12. A method for operating an injector, comprising: injecting with the injector an amount of liquid fuel into a combustion chamber of an internal combustion engine; wherein the amount of liquid fuel supplied to the combustion chamber is calculated depending on an actuator control signal of an actuator of the injector for the liquid fuel by using an injector model, and wherein the actuator control signal is corrected in case of deviations between a target value for the amount of liquid fuel and the calculated amount.
